(19) United States
(12) Patent Application Publication
(10) Pub. No.: US 2003/0170092 A1
(43) Pub. Date: Sep. 11, 2003

(54) Releasable fasteners

(76) Inventors: Joseph David Chiodo, London (GB); Eric Billett, Kent (GB)

Correspondence Address: Watts Hoffmann Fisher & Heinke Co, Suite 1750, 1100 Superior Ave, Cleveland, OH, 44114, US

(21) Appl. No.: 10/168,515

(22) PCT Filed: Dec. 21, 2000
(86) PCT No.: PCT/GB00/04954

(51) Int. Cl. F16B 1/00

(52) U.S. Cl. 411/82.5

(57) ABSTRACT

A releasable fastener made of or containing a shape memory material or mechanical property loss effect material has an active shape in which it can function as a fastener. When heated, e.g. by microwave radiation, the fastener relaxes to a passive shape in which it no longer functions as a fastener, thus permitting disassembly of the fastened components.

This invention relates to fasteners which use a shape memory effect, or a mechanical property loss, to release the fastener. The fasteners are especially suitable for use in the active disassembly of a product, but the invention is not limited exclusively to this field. The invention is applicable to fasteners using alloys and/or polymeric materials.

Reference is made to our prior patent application GB-A-2320277 which discloses techniques employing shape memory materials to facilitate the “active” disassembly of a product at the end of the product's life. The recovered parts or materials can be recycled, or they can be disposed of safely according to the type of material.

Mechanical Property Loss Materials

One aspect of the present invention relates to a technique using polymeric materials which are not, strictly speaking, shape memory materials. Instead, this aspect of the invention provides a releasable fastener comprising a mechanical property loss effect polymer.

As used herein, the term “mechanical property loss” (MPL) effect polymer refers to a polymer which, upon heating, passes through a rubbery state before becoming fluid. Suitable materials include, for example, thermoplastic polymers.

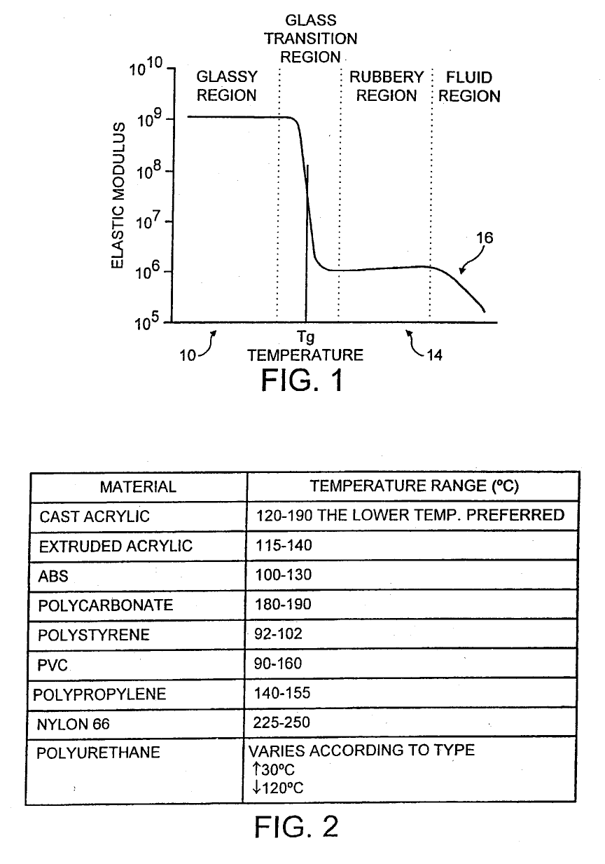

FIG. 1 is a graph which illustrates this behaviour in terms of the material's elastic modulus as a function of temperature. In a low temperature region-10, the plastics is in its glassy region, in which the plastics is dimensionally stable, with a relatively high modulus. As the temperature is increased and enters a transition band 12, the material begins to become rubbery, and the elastic modulus falls progressively. The temperature in the middle of the transition band is referred to as the transition temperature (Tg) at which stage the material is part stable and part rubbery. Above the transition band 12, the material enters its fully rubbery state 14. As the temperature is further increased, the plastics becomes fluid (region 16) and can be used, for example, in an injection moulding process. However, in one aspect, the rubbery region 14 is of particular interest, as the plastics can provide a sharp mechanical property loss, allowing the fastener to release, without melting or burning the plastics. In other words, the material becomes rubbery such that the fastener can fail, for example, when under load. In other forms, the rubbery region may be relatively narrow, such that the polymer rapidly melts to provide the mechanical property loss.

Certain MPL effect polymers may also exhibit some shape memory behaviour. However, the materials do not fall within the normal definition of a shape memory polymer, because the effect is so weak, and the material does not tend to return fully to its original shape. The dominant effect is the MPL effect.

Any suitable form of MPL fastener may be used, for example, a threaded screw or bolt, a threaded nut, a clip, a tie, rivet or clasp. This list is merely illustrative, not exhaustive.

The MPL fastener may be a discrete unit, or it may be formed integrally with a member to be fastened. For example, an integral MPL effect nut may be moulded as part of a case.

FIG. 2 shows typical material parameters for a range of suitable plastics which exhibit a useful MPL effect. These materials are shown for example only; the invention is not limited to the polymers listed.

In a closely related aspect, the invention provides an article comprising means for facilitating automatic disassembly of the article, said means comprising a MPL effect polymer.

Preferably, the means is in the form of a fastener for fastening one part of the article to another.

Preferably, the article further comprises means for urging first and second parts of the article away from each other when the MPL effect polymer is released or relaxed.

In a further closely related aspect, the invention provides a method of at least partly disassembling an article comprising MPL effect polymeric material, the method comprising heating the MPL effect material directly or indirectly, to cause the MPL effect material to suffer a mechanical property loss.

In a further closely related aspect, the invention provides apparatus having a MPL effect provided by one or more of the following materials:

acrylic; ABS; polycarbonate; polystyrene; PVC; polypropylene; nylon; polyurethane.

Shape Memory Effect Fasteners

In developing another aspect of the present invention, it has been appreciated that, although it should be possible to produce shape memory material fasteners which have an equivalent shape to existing fasteners (such as screws, bolts, nuts, clips and rivets), in practice this is far from straightforward. The present invention has been devised bearing the above in mind.

In a first aspect, the invention provides a method of forming a fastener comprising shape memory material in at least a predetermined engagement region thereof, the method comprising:

providing a blank for the fastener without the engagement region;

applying external pressure to a region of the blank while subjecting the region directly or indirectly to a temperature in or greater than the transition temperature region (Tg) for the shape memory material, to mould the engagement region on to the blank; and

maintaining the external pressure while the material cools to below the transition temperature region.

The method may be used with shape memory alloys, but is especially suitable for use with shape memory polymers.

The formed engagement region may, for example, be a thread. Such a thread may be formed on the post of a screw or bolt blank, or on the interior surface of a nut blank.

The engagement region may alternatively comprise a head. For example, the head may be formed on a pre-threaded screw or bolt blank, or it may be formed on a rivet blank.

Preferably, the external pressure is applied in such a manner as to cause the material to flow, or to deform, to form the engagement region.

In use, when the fastener is subsequently subjected to a temperature in the region of or exceeding the transition temperature, the engagement region collapses or returns to its original blank shape, such that the fastener is released.

In a closely related aspect, the invention provides a method of forming a fastener comprising shape memory material in at least an engagement region thereof, the method comprising:

providing a blank of the fastener with the engagement region in a passive position;

deforming the engagement region into an active position while subjecting the region directly or indirectly to a temperature in or greater than the transition temperature region (Tg) for the shape memory material; and

maintaining the engagement region in the active position while the material cools to below the transition temperature region.

The method may be used with shape memory alloys, but is especially suitable for use with shape memory polymers.

The fastener may, for example, comprise a clip with a movable engagement region in the form of a tongue or finger.

In use, when the fastener is subsequently subjected to a temperature in or exceeding the transition temperature, the engagement region collapses or returns to its original passive position, thereby releasing the fastener engagement.

In a further closely related aspect, the invention provides a method of attaching a fastener having an engagement region of shape memory material, to a member having an undercut aperture therein, the method comprising:

inserting the engagement region into the aperture;

applying pressure to deform the engagement region to form an engagement fit within the undercut aperture, while subjecting the engagement region directly or indirectly to a temperature in or greater than the transition temperature region (Tg) for the shape memory material; and

maintaining the engagement region in its deformed condition while the material cools to below the transition temperature region.

The method may be used with shape memory alloys, but is especially suitable for use with shape memory polymers.

The above method can provide an extremely convenient technique for attaching a fastener in a releasable manner to the undercut aperture. The fastener becomes moulded to match the undercut shape of the aperture, whereby the fastener is locked in the aperture. In use, when the fastener is subsequently subjected to a temperature exceeding the transition temperature, the moulded region collapses or returns to its original shape, thereby releasing the locking engagement with the undercut aperture.

In a further closely related aspect, the invention provides a method of forming a fastener comprising:

providing first and second parts of the fastener, at least one of the parts being of shape memory material or MPL effect material; and

assembling the first and second parts together to form the fastener.

The part of shape memory material or MPL effect material may be trained by shaping the part while subjecting the part region directly or indirectly to a temperature exceeding the transition temperature for the shape memory material. Such training may be performed before, or after, the first and second parts are joined together.

The first and second parts may, for example, be permanently secured together, for example by bonding. Alternatively, they may be secured together by mechanical keying, or by a mechanical interlock.

In a further closely related aspect, the invention provides a method of heating a shape memory polymer or a MPL effect polymer, the polymer comprising or containing microwave absorbing material, the method comprising subjecting the material to microwave radiation.

The microwave absorbing material may interact with the electric field vector or with the magnetic field vector of the microwave radiation.

In order to generate heat from the electric field vector, the material should provide a moderate or high resistance electrical path. The conductive material may either be a poorly conductive material, or a good conductor provided in discrete or particle form. Suitable materials include carbon, iron, aluminium and zinc. The material may be provided in granular or fibrous form, and distributed in the shape memory material. Carbon is a particularly preferred material, as it is available in batch powder and fibre forms, and it bonds well to a plastics matrix.

Suitable material capable of interacting with the magnetic field vector include polycrystalline magnetic materials.

In a further closely related aspect, the invention provides a fastener having at least an engagement region comprising shape memory material, the engagement region being configured, when subjected to a temperature in or exceeding a transition temperature region (Tg), to change its configuration to a non-engaging condition.

In a further closely related aspect, the invention provides a fastener having at least an engagement region comprising shape memory material or MPL effect material, the engagement region being configured, when subjected to a temperature in or exceeding a transition temperature region (Tg), to lose structural integrity.

In a further closely related aspect, the invention provides a fastener comprising shape memory material or MPL effect material, the material being loaded with microwave absorbing material able to generate heat within the material when the fastener is irradiated with microwave radiation.

In a further closely related aspect, the invention provides apparatus comprising electronic display means and mounting means comprising shape memory material or MPL effect material for mounting the electronic display means within the apparatus, the mounting means being configured to release the electronic display means when subjected to a temperature in or exceeding a transition temperature region for the material.

In a further closely related aspect, the invention provides apparatus having a shape memory effect provided by one or more of the following materials:

acrylic; ABS; polycarbonate; polystyrene; PVC; polypropylene; nylon; polyurethane.

In a further closely related aspect, the invention provides a case comprising first and second case portions, at least one of the case portions comprising a case fastener providing a shape memory or MPL effect, and wherein, when the case is subjected directly or indirectly to a temperature in or exceeding the transition temperature range, the first and second case portions are separable from each other.

In a further closely related aspect, the invention provides an article comprising a plurality of MPL effect fasteners and wherein at least two of the fasteners are configured to be released at different release temperatures.

In a further closely related aspect, the invention provides an article having a first portion disassemblable from a second portion by subjecting the article directly or indirectly to an increased temperature. Preferably, the article comprises a MPL effect material.

Embodiments of the invention are now described, by way of example only, with reference to the accompanying drawings, in which:

FIG. 1 is a graph illustrating behaviour of a typical shape memory polymer;

FIG. 2 is a table of polymer properties;

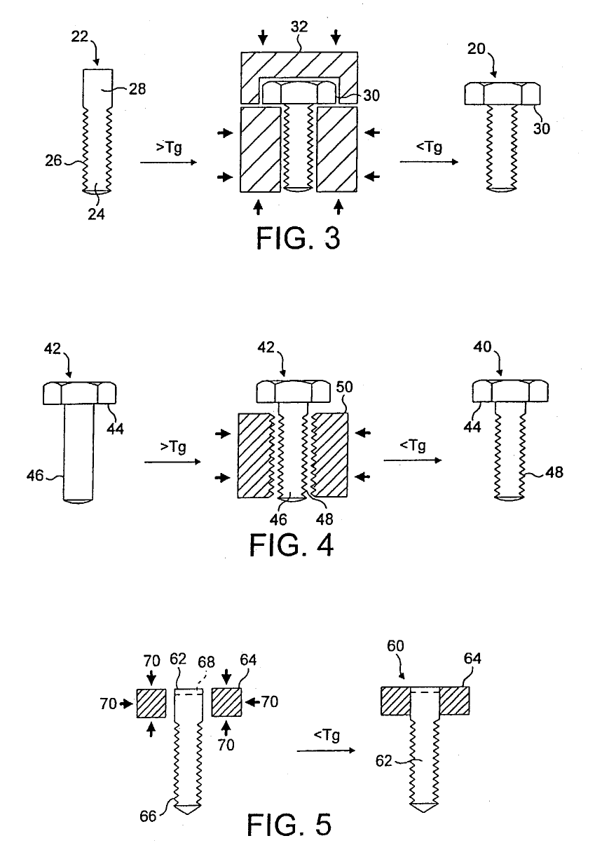

FIG. 3 is a schematic representation of the formation of a first embodiment of fastener;

FIG. 4 is a schematic representation of the formation of a second embodiment of fastener;

FIG. 5 is a schematic representation of the formation of a third embodiment of fastener;

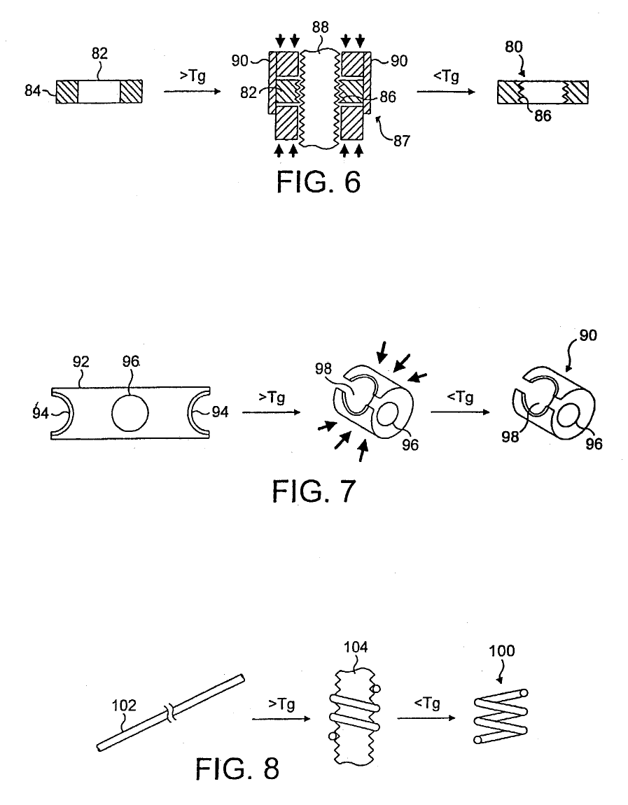

FIG. 6 is a schematic representation of the formation of a fourth embodiment of fastener;

FIG. 7 is a schematic representation of the formation of a fifth embodiment of fastener;

FIG. 8 is a schematic representation of the formation of a sixth embodiment of fastener;

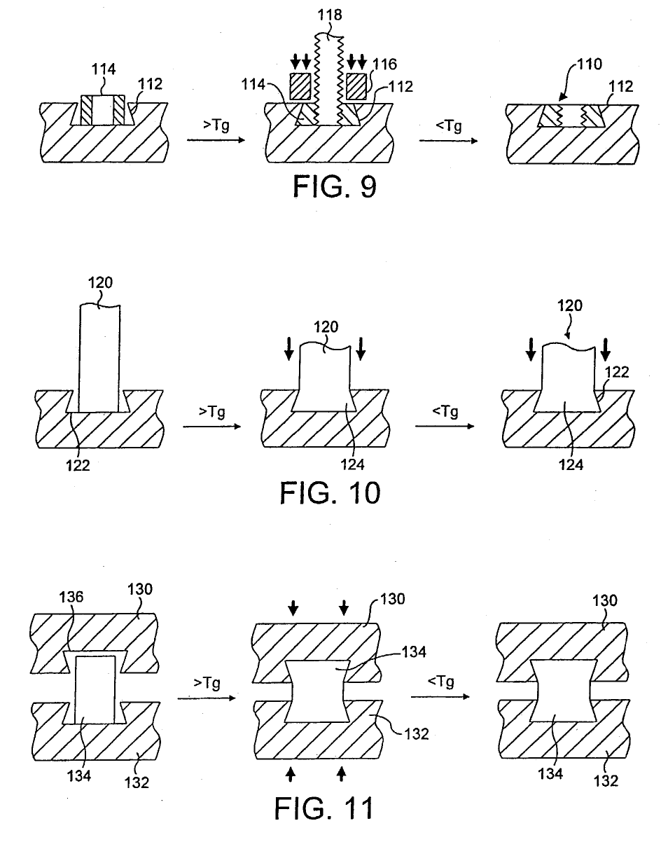

FIG. 9 is a schematic representation of the formation of a seventh embodiment of fastener;

FIG. 10 is a schematic representation of the formation of an eighth embodiment of fastener;

FIG. 11 is a schematic representation of the formation of a ninth embodiment of fastener;

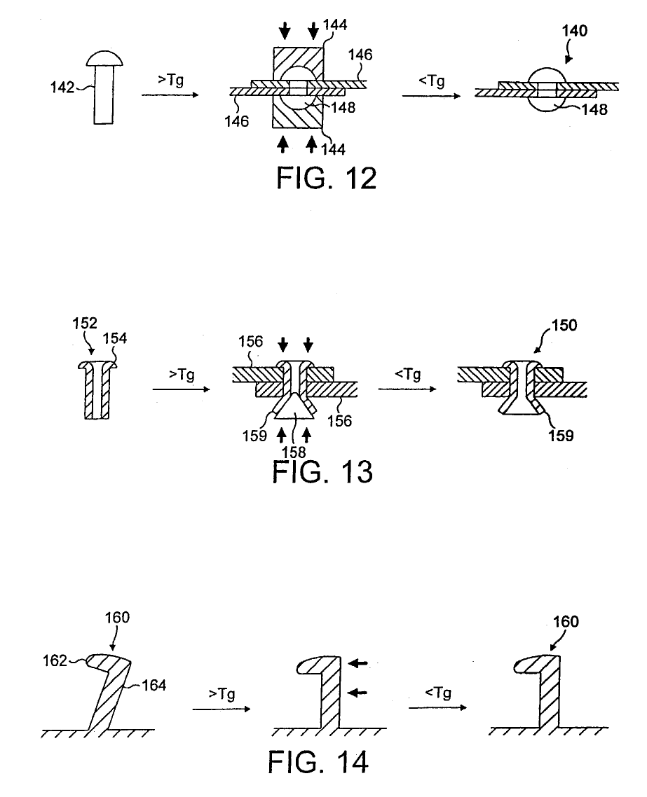

FIG. 12 is a schematic representation of the formation of a tenth embodiment of fastener;

FIG. 13 is a schematic representation of the formation of an eleventh embodiment of fastener;

FIG. 14 is a schematic representation of the formation of a twelfth embodiment of fastener;

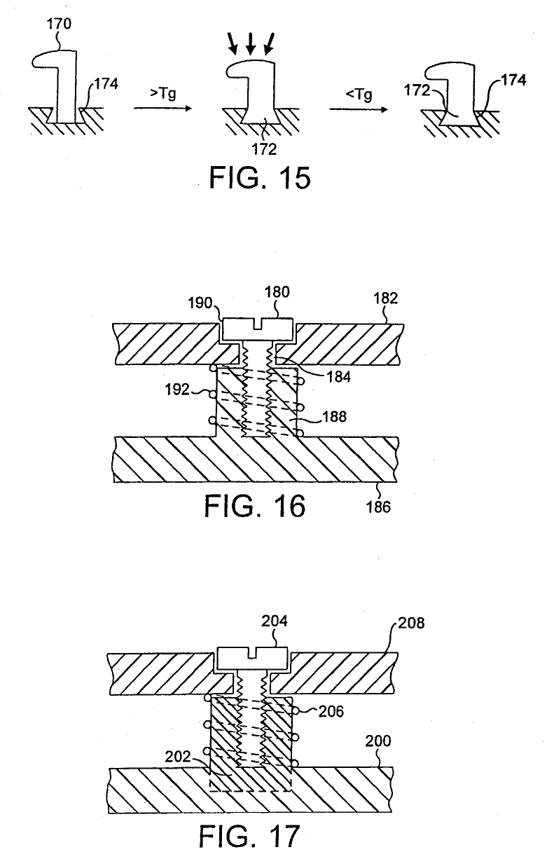

FIG. 15 is a schematic representation of the formation of a thirteenth embodiment of fastener;

FIG. 16 is a schematic representation of the use of a fourteenth embodiment of fastener; and

FIG. 17 is a schematic representation of the use of a fifteenth embodiment of fastener.

The following embodiments illustrate the formation of various designs of fastener employing shape memory material to provide an automatic shape memory effect to release the fastener, in use. The designs can address problems encountered in implementing fastener designs in shape memory material. For example, for shape memory polymers, problems may be encountered in terms of material creep, material strength, mouldability of detail, and return to shape when activated above the transition temperature of the material. Also, for shape memory alloys, there may be problems of work hardening of the material. For example, some alloys have been found to work harden with just 6% strain.

Although the following description focuses on shape memory materials, it will be appreciated from later description that precisely the same principles may be used to form fasteners of a MPL effect material.

The following discussion of the first four embodiments concentrates on fasteners made of shape memory polymer. However, it will be appreciated that the same principles could be used to produce fasteners of shape memory alloy.

FIG. 3 illustrates schematically the formation of a first embodiment of a screw threaded fastener, in the form of a screw or bolt 20. The bolt 20 is firstly formed as a blank 22 by high temperature injection moulding. The blank 22 comprises a shank 24 carrying a screw thread 26, and an upper region 28. In order to form the bolt head 30, the blank 22 is placed in a press 32, and is subjected to an elevated temperature. The temperature is sufficient to reach or exceed the transition temperature (Tg) of the material, but is not so high that the plastics becomes fluid. As the material exceeds Tg, it becomes rubbery, enabling the head 30 to be formed or moulded in the press. The bolt is held in its formed shape in the press 32 as the bolt 20 is allowed to cool again below Tg, at which time the bolt 20 becomes dimensionally stable in its final form with the head 30. In the form shown in FIG. 3, the head has a hexagonal shape.

In use, the bolt 20 can be threadedly engaged in place as a conventional fastener.

When the bolt 20, or more exactly the bolt head 30, is subjected directly or indirectly to a temperature in the region of, or exceeding, Tg, the bolt head again becomes rubbery, and tends to return to its original shape 28 of the blank 22. This change in shape of the bolt head 30 can provide instant release of the fastener, and is especially suitable for active disassembly applications of products for recycling or disposal.

The performance of the bolt 20 is enhanced by the following two features:

(a) At Tg, the plastics material exhibits a sharp property loss. If the bolt is under fastening tension, then the fastening will be released.

(b) The plastics material tends to return to its original shape 28 in which there is no engaging region in the form of the fastening head 30.

This combination of features can provide excellent performance in use, and can also provide reliable releasing of the fastener when subjected to a temperature above Tg.

The bolt 20 is especially suitable for use as an external fastener for a case, as the bolt head 30 will lie outside the case. This makes it easier for externally applied heat to reach the bolt head 30 when, for example, the case is placed in an oven in order to release the fastener.

In this embodiment, the screw thread 26 is preformed with the blank 22 rather than being moulded in the press 32. This enables a small, or a fine pitch, screw thread to be moulded. It can be difficult to shape small mould details when in the press 32 because, in the rubbery state, small shape changes are not always retained faithfully by the plastics.

If a screw driver slot, or cross-head, is required in the head 30, then it is preferred that this be formed during the injection moulding of the blank 22, for the same reasons as those discussed for the screw thread 26. However, the press 32 would have to be configured not to destroy the screwdriver slot or cross-head during the formation of the head 30.

FIG. 4 illustrates the formation of a second embodiment of screw threaded fastener in the form of a second screw or bolt 40. In the second embodiment, a blank 42 is formed which has a ready moulded head 44. However, the shank 46 is formed without a screw thread. The thread 48 is impressed on the shank 46,when the blank 42 is inserted into a press 50, and the bolt 40 heated to the region of, or to exceed, Tg. The bolt is then allowed to cool in the press, to retain the thread 48 on the shank 46.

In view of the limitations explained above on forming fine shapes during the rubbery phase, this embodiment is suitable for forming relatively coarse threads, for example, for screwing into plastics. This embodiment does, however, enable a screwdriver slot or cross-head or Allen-key recess (not shown) to be moulded into the head 44 without risk of damage to the head while the blank is in the press 50.

FIG. 5 illustrates the formation of a third embodiment of screw threaded fastener in the form of a screw or bolt 60. In this embodiment, the bolt 60 comprises a shank part 62 and an annular head part 64 which are secured together. This embodiment differs from the preceding embodiment in that only the active part has to be made of the shape memory material, whether a shape memory alloy or a shape memory polymer. In this embodiment, the active part is the head 64, although it will be appreciated that the same principles could also be applied to an active shank.

The shank part 62 is preformed with a screw thread 66 and a screwdriver slot 68. In order to assemble the bolt 60, a press 70 is used which applies pressure to compress the annular head part 64 on to the shank part 62, while the head part 64 is subjected to a temperature in the region of, or above, Tg (i.e. in the rubbery phase). If the shank part 62 and the head part 64 are of plastics capable of bonding to each other, then no mechanical interlock or keying is necessary between the shank and the head parts. However, such an interlock will be required if the two materials are non-compatible and it may also be used if desired even if the materials are bonding compatible. If desired, one part could be of metal, and the other part of plastics.

In use, when the fastener 60 is subjected to an elevated temperature in the region of, or above, Tg, the annular head part 64 will expand back to its original shape and release engagement with the shank part 62, thereby falling off the shank part.

FIG. 6 illustrates the formation of a fourth embodiment of screw threaded fastener in the form of a nut 80. The nut is formed initially as an annular blank 82 having a multi-faced exterior surface 84, but without any interior screw thread. The thread 86 is formed by placing the blank 82 into a press 87 having a screw threaded central former 88, and an outer wall 90. When the press is operated while the blank 82 is subjected to an elevated temperature in the region of, or above, Tg, the blank is compressed and is forced inwardly against the former 88 to impress the thread 86 on the inner surface of the nut 80.

When in use, and subjected subsequently to a temperature in the region of or exceeding Tg, the nut 80 suffers mechanical property loss and returns to its original shape as a blank 82 without a thread 86. This enables the nut 80 to release its fastening engagement.

It will be appreciated that the principles illustrated in FIG. 5 may also be used to provide a two-part nut, having an annular inner screw threaded part, and an annular outer multi-faced part. Either part may be selected as the active part, as desired.

FIG. 7 illustrates a fifth embodiment of screw threaded fastener in the form of a nut 90. This embodiment is especially suitable for implementing a nut in shape memory alloy, because the amount of strain required to form the nut 90 is relatively small. This reduces the risk of work hardening which might otherwise limit the usefulness of the shape memory effect.

The nut 90 is formed from a blank 92 in the form of a strip having near semicircular cut-outs 94 at either end. A central aperture 96 may also be provide near the centre of the strip.

To form the nut, the ends of the strip are bent towards each other, such that the cut-outs 94 co-operate to form an aperture 98 for engaging the screw thread of a bolt (not shown). The aperture 98 should be dimensioned to match the size of bolt on to which the nut is intended to be threaded. The blank 92 is folded while subjected to an elevated temperature in the region of, or above, Tg, and is allowed to cool in the folded configuration to retain the nut shape.

The central aperture 96 lines up with the main aperture 98 to allow a bolt to pass through the nut, if desired. If the central aperture 96 is omitted then the nut can still be threaded on to the end of a bolt using the main aperture 98, but the nut 90 can only be screwed by an amount corresponding to the diameter of the nut.

When the nut is again subjected to a temperature in the region of or above Tg, the nut 90 unfolds and returns to the linear strip shape of the blank 92, thereby releasing engagement with the bolt.

FIG. 8 shows a sixth embodiment of screw threaded fastener in the form of a helical nut 100. The nut is formed from a wire 102 which is wound around a screw threaded former 104 to give the nut its helical shape, while being subjected to a temperature in the region of or above Tg. The nut is retained on the former 104 while the material cools below Tg, such that the nut 100 retains its shape when cool.

When, in use, the nut 100 is subjected to an elevated temperature in the region of or above Tg, the nut 100 unwinds back to its original straight wire shape, thereby releasing any threaded engagement.

As with the previous embodiment, the present embodiment is especially suitable for use with shape memory alloy material as the bending involves only modest strain, and there is therefore less risk of work hardening of the material.

FIG. 9 illustrates schematically the formation of a seventh embodiment of a screw threaded fastener, in the form of a self locating nut 110, received in an undercut aperture 112. The nut 110 is provided initially in the form of an annular blank 114, able to fit into the aperture 112. Initially, the blank does not have an internal thread.

The nut 110 is formed by the downward application of pressure using a press 116, and insertion of a screw threaded former 118 into the central aperture, while the nut 110 is subjected to a temperature in the region of, or greater than, Tg. The material in its rubbery state is forced into the undercut of the aperture 112, and is also forced against the former 118 which impresses the thread on the interior of the nut 110. The former 118 and the press 116 are retained in position until the nut 110 cools below Tg, whereafter it will retain its new shape. The former 118 can subsequently be removed by unscrewing from the nut 110. If desired, the undercut may be generally conical, or it may have one or more faces to prevent rotation of the nut within the aperture.

In use, a bolt or other threaded shaft (not shown) can be threadedly received in the nut 110 to act as a fastener.

In order to disassemble the fastener, the nut 110 is subjected to a temperature again in the region of, or exceeding, Tg. The nut 110 will then lose it structural integrity, returning to the shape of the blank 114. The nut will then either be free to fall out of the aperture 112, or to release the engagement of the bolt, or a combination of both.

FIG. 10 illustrates schematically the formation of an eighth embodiment of fastener. This is similar to the principle of the nut 110 described above, except that there is no threaded engagement. Instead, a post 120 is secured in an undercut aperture 122. Initially, the post has a “blank” end which is capable of being received within the aperture. Upon the application of downward pressure, while subjecting the post 120 to a temperature in the region of, or exceeding, Tg, the end 124 of the post 120 expands to fill the undercut, and lock the post 120 in position. The downward pressure is maintained until the temperature cools below Tg, such that the end 124 maintains its expanded shape.

The post releases automatically upon subjection to a temperature in the region of, or exceeding, Tg. At such a high temperature, the post 120 returns to its original “blank” shape, such that it is easily withdrawn from the aperture 122.

FIG. 11 illustrates schematically the formation of a ninth embodiment of fastening, using principles very similar to those of the eighth embodiment. Two devices, 130 and 132 (for example, electronic circuit boards) are secured together by a short post 134 which is received in an undercut aperture 136 formed in each item.

FIG. 12 illustrates schematically the formation of a tenth embodiment of fastener, in the form of a double headed rivet 140. Initially, the rivet 140 is provided as a mushroom headed blank 142, which may be formed by injection moulding. The rivet 140 is formed in situ by clamping the blank 142 in a press 144 on either side of the articles 146 to be fastened together, while subjecting the rivet to a temperature in the region of, or exceeding, Tg. A lower mushroom head 148 is formed. The press 144 is retained in position until the rivet 140 has cooled below Tg, whereafter it will retained its final shape to secure the articles together.

In order to release the rivet 140, the temperature is elevated to the region of, or above, Tg again. This causes the lower mushroom head 148 to lose structural integrity, and to return to the original shape of the blank 142.

FIG. 13 illustrates schematically the formation of an eleventh embodiment of fastener in the form of a pop rivet 150. The rivet 150 is provided in the form of a tubular blank 152 having a lip 154 at one end. The blank can be, inserted through apertures to secure two articles 156 together.

The rivet is formed in situ by pressing a conical wedge 158 into the lower end of the blank 152, while subjecting the blank to a temperature in the region of, or exceeding, Tg. In its rubbery state, the lower end is deformed to flare outwardly (at 159) to secure the rivet in position. The wedge 158 is retained in position until the rivet 150 has cooled to below Tg.

To release the rivet 150, it is again subjected to a temperature in the region of or exceeding Tg, which causes the flared end 159 to collapse and return to its original tubular shape, thereby loosening the rivet.

FIG. 14 illustrates schematically the formation of a twelfth embodiment of fastener, in the form of a snap fit tooth 160. The tooth 160 is formed as an undercut projection 162 projecting from a post 164. Initially, the tooth 160 is provided in a “passive” or non-gripping configuration, for example, inclined rearwardly. The tooth is placed into its “active” position by heating the tooth to about, or above, Tg until it becomes rubbery, and displacing the tooth into its “active” position, for example, generally upright. Pressure is applied to maintain the tooth in its “active” position until the tooth has cooled below Tg.

To release the snap fit tooth 160, i.e. to move the tooth from its “active” (upright) position to its “passive” (rearwardly inclined) position, it is necessary simply to subject the tooth 160 to a temperature in the region of, or exceeding, Tg. The tooth will lose its mechanical property holding the tooth upright, and tend to relax to its “passive” position.

Such a tooth may, for example, be used to hold a printed circuit board, or it may be used to secure two case parts together, to provide automatic release or opening at an appropriate temperature.

Multiple such teeth may be provided. For example, a pair of teeth could be arranged on a first part and arranged to relax towards or away from each other to enable a second part to be moved relative to the first part.

FIG. 15 illustrates schematically the formation of a thirteenth embodiment, very similar to the twelfth embodiment, but modified to locate a foot 172 in an undercut aperture 174 in the same manner as that described for FIG. 10. The tooth 170 may be configured to be movable (as in the preceding embodiment) and/or it might be dislodgeable from the undercut aperture (as in the embodiment of FIG. 10).

Although the above description focuses on fasteners of shape memory material, the same principles may be applied to fasteners of MPL effect material. In particular, the embodiments of FIGS. 9 to 15 are especially suitable for implementing with MPL material.

As a further example, FIG. 16 illustrates the use of a further embodiment of a fastener in the form of a bolt 180 of MPL effect material. Since the bolt does not have rely on a shape memory effect, the bolt may be injection moulded using a single stage moulding process.

As seen in FIG. 16, in this example, the bolt 180 is used to secure a first case part 182 having an aperture 184, to a second case part 186 having a region 188 into which the bolt 180 is threadedly engaged.

In use, to disassemble the case parts 182 and 186, the case (or the bolt) is subjected directly or indirectly to a temperature in the region of, or exceeding, the transition temperature for the MPL effect material. This causes the bolt 180 to lose its structural integrity by becoming rubbery. The bolt 180 may be released either by loss of threaded engagement with the region 188, or by the head 190 of the bolt becoming weak and deformable, or by a combination of both.

As shown in phantom in FIG. 16, a spring 192 may be provided to urge the first and second parts 182 and 186 away from each other when the bolt 180 “relaxes”.

Referring to FIG. 17, a further embodiment comprises a case part 200 made generally of a first plastics material, and comprising an integrally moulded region 202 of MPL effect material. The region 202 has a bore therein for receiving the threaded shank of a conventional bolt 204 (which may be of metal or plastics).

When it is desired to release the fastening, the region 202 is subjected directly or indirectly to an elevated temperature in the region of, or exceeding, the transition temperature Tg. This causes the integrally moulded second region 202 to loose its structural integrity, and to release the bolt 204. As in the embodiment of FIG. 15, a spring or other biasing device 206 may be provided to urge the two parts 200 and 208 away from each other, or to urge the bolt out of its threaded aperture.

This embodiment may provide practical advantages compared to the embodiment of FIG. 16, by enabling a greater torsional load to be applied to the bolt (compared to the relatively weak bolt 180 of FIG. 16).

Various techniques can be employed to apply heat to the shape memory materials and/or to the MPL effect materials, for example, an elevated temperature oven, or infra red illumination, or induction heating. In a preferred form, microwave radiation is used to generate beat within the material. This is achieved by loading the polymeric material with microwave absorbing material, for interacting either with the electric field vector or with the magnetic field vector of the radiation. Suitable materials for generating heat from the electric field vector include graphite, iron particles, zinc particles, or aluminium particles. The use of particles provides an electrically resistant path, in which heat is generated by the induction of a current. Suitable materials for generating heat from the magnetic vector include polycrystalline magnetic materials.

The use of microwave radiation to provide a heating effect can enable releasable fasteners to be used internally where it might not otherwise be practical to provide direct application of heat. It can also improve the heating efficiency by enabling the heating to be concentrated in those areas configured for absorbing microwave radiation, and enable heat to be generated within certain regions without risking heat damage to other regions or, for example, to other electronic components.

Microwave radiation may heat the active part directly, by being absorbed in the active part. Alternatively, the microwave radiation may heat the active part indirectly, by being absorbed in a region in thermal contact with the active part, such as a separate component which abuts against the active part. For example, if a biasing device is being used, the biasing device could also absorb the microwave radiation. The two techniques (direct and indirect heating) may be used together.

Also, as illustrated in FIG. 2, by selecting materials having different transition temperatures Tg, it is possible to provide sequential triggering of materials at progressively increasing temperatures.

For example, the following materials could be used to provide a shape memory or a MPL effect occurring over the following temperature ranges:

Polyurethane from about 30° C. to about 100° C.

ABS around 100° C.

Polypropylene around 140° C.

Nylon 150° C.-230° C. (according to type)

If even higher temperatures are required, then other materials, such as PEEK and PPO might also be used.

The present invention is particularly suitable for providing mountings, internal fastenings and automatic releases, for:

Liquid crystal displays (LCD's)

Display covers

Electronic components and modules

Battery containers and casings, and openable shells or chambers in which a battery may be arranged

Mobile products and communication devices

Apparatus cases and housings.

It will be appreciated that the foregoing description is merely illustrative of preferred forms of the invention, and that many modifications may be made within the scope of the invention. Features believed to be of particular significance are defined in the appended claims. However, the Applicant claims protection for any novel feature or idea described herein and/or illustrated in the drawings whether or not emphasis has been placed thereon.

1. A releasable fastener comprising a mechanical property loss effect polymer.

2. An article comprising a non-MPL member to be fastened and, integral therewith, a fastener according to claim 1.

3. An article comprising means for facilitating automatic disassembly of the article, said means comprising a MPL effect polymer.

4. An article according to claim 3, wherein the means is in the form of a fastener for fastening one part of the article to another.

5. An article according to claim 3 or 4, further comprising means for urging first and second parts of the article away from each other when the MPL effect polymer is released or relaxed.

6. A method of at least partly disassembling an article comprising MPL effect polymeric material, the method comprising heating the MPL effect material directly or indirectly, to cause the MPL effect material to suffer a mechanical property loss.

7. Apparatus having a MPL effect provided by one or more of the following materials:
acrylic; ABS; polycarbonate; polystyrene; PVC; polypropylene; nylon; polyurethane.

8. A method of forming a fastener comprising shape memory material in at least a predetermined engagement region thereof, the method comprising:
providing a blank for the fastener without the engagement region;
applying external pressure to a region of the blank while subjecting the region directly or indirectly to a temperature in or greater than the transition temperature region (Tg) for the shape memory material, to mould the engagement region on to the blank; and
maintaining the external pressure while the material cools to below the transition temperature region.

9. A method according to claim 8, wherein the shape memory material is a shape memory polymer.

10. A method according to claim 8 or 9, wherein the engagement region is a thread.

11. A method according to claim 10, wherein the blank is a screw or bolt blank.

12. A method according to claim 10, wherein the blank is a nut blank.

13. A method according to claim 8 or 9, wherein the engagement region is a head.

14. A method according to claim 13, wherein the blank is a pre-threaded screw or bolt blank.

15. A method according to claim 13, wherein the blank is a rivet blank.

16. A method according to any one of claims 9 to 15, wherein the external pressure is applied in such a manner as to cause the material to flow, or to deform, to form the engagement region.

17. A method of forming a fastener comprising shape memory material in at least an engagement region thereof, the method comprising:
providing a blank of the fastener with the engagement region in a passive position;
deforming the engagement region into an active position while subjecting the region directly or indirectly to a temperature in or greater than the transition temperature region (Tg) for the shape memory material; and
maintaining the engagement region in the active position while the material cools to below the transition temperature region.

18. A method according to claim 17, wherein the shape memory material is a shape memory polymer.

19. A method according to claim 17 or 18, wherein the fastener is a clip with a movable engagement region in the form of a tongue or finger.

20. A method of attaching a fastener having an engagement region of shape memory material, to a member having an undercut aperture therein, the method comprising:
inserting the engagement region into the aperture;
applying pressure to deform the engagement region to form an engagement fit within the undercut aperture, while subjecting the engagement region directly or indirectly to a temperature in or greater than the transition temperature region (Tg) for the shape memory material; and
maintaining the engagement region in its deformed condition while the material cools to below the transition temperature region.

21. A method according to claim 20, wherein the shape memory material is a shape memory polymer.

22. A method of forming a fastener comprising:
providing first and second parts of the fastener, at least one of the parts being of shape memory material or MPL effect material; and
assembling the first and second parts together to form the fastener.

23. A method according to claim 22, wherein the part of shape memory material is trained by shaping the part while subjecting the part region directly or indirectly to a temperature exceeding the transition temperature for the shape memory material.

24. A method according to claim 22 or 23, wherein the first and second parts are permanently secured together.

25. A method according to claim 24, wherein the first and second parts are bonded together.

26. A method according to claim 22 or 23, wherein the first and second parts are secured together by mechanical keying.

27. A method according to claim 22 or 23, wherein the first and second parts are secured together by a mechanical interlock.

28. A method of heating a shape memory polymer or a MPL effect polymer, the polymer comprising or containing microwave absorbing material, the method comprising subjecting the material to microwave radiation.

29. A method according to claim 28, wherein the microwave absorbing material provides a moderate or high resistance electrical path which interacts with the electric field vector of the microwave radiation in order to generate heat.

30. A method according to claim 29, wherein the microwave absorbing material comprises a good electrical conductor provided in discrete or particle form.

31. A method according to claim 29, wherein the microwave absorbing material is provided in granular or fibrous form and is distributed in a matrix of the shape memory material.

32. A fastener having at least an engagement region comprising shape memory material, the engagement region being configured, when subjected to a temperature in or exceeding a transition temperature region (Tg), to change its configuration to a non-engaging condition.

33. A fastener having at least an engagement region comprising shape memory material or MPL effect material, the engagement region being configured, when subjected to a temperature in or exceeding a transition temperature region (Tg), to lose structural integrity.

34. A fastener comprising shape memory material or MPL effect material, the material being loaded with microwave absorbing material able to generate heat within the material when the fastener is irradiated with microwave radiation.

35. Apparatus comprising electronic display means and mounting means comprising shape memory material or MPL effect material for mounting the electronic display means within the apparatus, the mounting means being configured to release the electronic display means when subjected to a temperature in or exceeding a transition temperature region for the material.

36. Apparatus having a shape memory effect provided by one or more of the following materials:
acrylic; ABS; polycarbonate; polystyrene; PVC; polypropylene; nylon; polyurethane.

37. A case comprising first and second case portions, at least one of the case portions comprising a case fastener providing a shape memory or MPL effect, and wherein, when the case is subjected directly or indirectly to a temperature in or exceeding the transition temperature range, the first and second case portions are separable from each other.

38. An article comprising a plurality of MPL effect fasteners and wherein at least two of the fasteners are configured to be released at different release temperatures.

39. An article having a first portion disassemblable from a second portion by subjecting the article directly or indirectly to an increased temperature.

40. An article according to claim 39, wherein the article comprises a MPL effect material.
